(19) United States
(12) Patent Application Publication
(10) Pub. No.: US 2022/0151029 A1
(43) Pub. Date: May 12, 2022

(54) Heater

(71) Applicant: Toshiba Lighting & Technology Corporation, Yokosuka-shi (JP)

(72) Inventor: Masaaki Takatsuka, Ehime-ken (JP)

(73) Assignee: Toshiba Lighting & Technology Corporation, Yokosuka-shi (JP)

(21) Appl. No.: 17/389,990

(22) Filed: Jul. 30, 2021

(30) Foreign Application Priority Data
Nov. 11, 2020 (JP) 2020-188146

(51) Int. Cl. H05B 3/44

(52) U.S. Cl. CPC H05B 3/44

(57) ABSTRACT

A heater according to an embodiment includes: a tubular portion; a sealing portion; a conductive portion; a heating element; a lead having one end portion side electrically connected to the conductive portion with the other end portion side exposed from the sealing portion; a connecting portion electrically connected to the exposed lead; an introduction wire having one end portion side electrically connected to the connecting portion; a base storing the sealing portion, the exposed lead, the connecting portion, and an end portion of the introduction wire; and a seal portion covering the exposed lead, the connecting portion, and the end portion of the introduction wire. The base has a first hole at a position facing the connecting portion. A length of the first hole in a pipe axial direction is longer than that of the first hole in a direction orthogonal to the pipe axial direction.

### CROSS-REFERENCE TO RELATED APPLICATIONS

This application is based upon and claims the benefit of priority from the Japanese Patent Application No. 2020-188146, filed on Nov. 11, 2020; the entire contents of which are incorporated herein by reference.

### FIELD

Embodiments described herein relate generally to heaters.

### BACKGROUND

Some heaters heat an object by means of radiant heat. Such a heater includes, for example, a bulb having sealing portions in both side end portions, a heating element provided in the bulb, a thin film-shaped conductive portion provided in the sealing portion, a lead exposed from the sealing portion, and a base where the sealing portion and the lead are stored.

In this case, the heating element has an end portion electrically connected to the conductive portion. One end of the lead is electrically connected to the conductive portion in the sealing portion, and the other end is exposed from the sealing portion. The base has insulating properties and stores the sealing portion and the lead exposed from the sealing portion. In addition, the lead and an introduction wire (harness) are electrically connected in the base.

Here, such a heater may require waterproofness. For example, when such a heater is used outdoors, it is required to prevent rainwater or the like from infiltrating into the base. In this regard, a technique for filling the base with a material such as a silicone resin has been proposed.

However, the base is filled with the material, and thus it is difficult to visually confirm the filling state. As a result, the material may not be sufficiently supplied to, for example, the connection part between the lead and the introduction wire and insufficient waterproofness (insulation) may arise.

In this regard, it has been desired to develop a heater capable of improving waterproofness.

### DESCRIPTION OF THE DRAWINGS

FIG. 1 is a schematic view for exemplifying a heater according to the present embodiment.

FIG. 2 is a schematic perspective view of a base.

FIG. 3 is a schematic view for exemplifying a heat generating portion according to another embodiment.

### DETAILED DESCRIPTION

A heater according to an embodiment includes: a tubular portion; a sealing portion provided in an end portion of the tubular portion; a conductive portion provided in the sealing portion; a heating element provided in the tubular portion, extending along a pipe axial direction of the tubular portion, and electrically connected to the conductive portion; a lead having one end portion side electrically connected to the conductive portion in the sealing portion with the other end portion side exposed from the sealing portion; a connecting portion electrically connected to the lead exposed from the sealing portion; an introduction wire having one end portion side electrically connected to the connecting portion; a base storing the sealing portion, the lead exposed from the sealing portion, the connecting portion, and an end portion of the introduction wire in an internal space; and a seal portion covering the lead exposed from the sealing portion, the connecting portion, and the end portion of the introduction wire in the space of the base, in which the base has a first hole communicating with the space at a position facing the connecting portion, and a length of the first hole in the pipe axial direction is longer than a length of the first hole in a direction orthogonal to the pipe axial direction.

Hereinafter, embodiments will be exemplified with reference to the drawings. It should be noted that similar components are denoted by the same reference numerals in the drawings with detailed description thereof omitted as appropriate.

A heater 100 according to the present embodiment is capable of heating an object or the space where the object is placed. In this case, the use of the heater 100 is not particularly limited. However, the heater 100 according to the present embodiment is provided with seal portions 130 as will be described later, and thus the heater 100 can be used even in an environment where waterproofness is required, examples of which include an outdoor environment.

In addition, although a so-called twin heater having two heat generating portions 1 will be described below as an example, exemplary embodiments described herein can also be applied to a heater having one heat generating portion 1 and a heater having three or more heat generating portions 1.

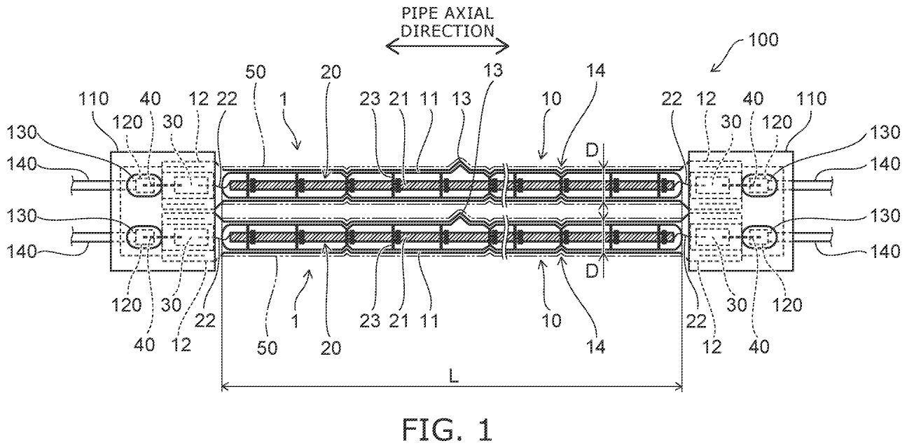

FIG. 1 is a schematic view for exemplifying the heater 100 according to the present embodiment.

As illustrated in FIG. 1, the heater 100 is provided with, for example, the heat generating portions 1, bases 110, connecting portions 120, and the seal portions 130.

The two heat generating portions 1 extend to one side and are provided side by side so as to be substantially parallel to each other.

Each of the heat generating portions 1 can be provided with, for example, a bulb 10, a heating element 20, a conductive portion 30, a lead 40, and a coating film 50.

The bulb 10 has, for example, a tubular portion 11, sealing portions 12, a protrusion portion 13, and dimples 14. The tubular portion 11, the sealing portions 12, the protrusion portion 13, and the dimples 14 can be integrally formed. The bulb 10 can be formed from, for example, transparent, that is, uncolored quartz glass or colored quartz glass.

The tubular portion 11 has, for example, a cylindrical shape. The tubular portion 11 has a total length L (length in the pipe axial direction). The total length L is longer than a pipe outer diameter D, which is the outer diameter of the tubular portion 11. It should be noted that the total length L of the tubular portion 11 may be referred to as an effective light-emitting length. When the pipe wall load on the inner wall of the tubular portion 11 becomes too high, the temperature of the tubular portion 11 becomes too high and the tubular portion 11 may be deformed or the durability of the tubular portion 11 may decrease. Accordingly, the pipe outer diameter D and the total length L (effective light-emitting length) of the tubular portion 11 can be appropriately determined in accordance with the electric power of the heater 100 so as not to exceed a predetermined pipe wall load. For example, the pipe outer diameter D can be approximately 12 mm and the total length L (effective light-emitting length) can be approximately 280 mm when the electric power of the heater 100 is 2000 watts (W).

Gas is sealed in the internal space of the tubular portion 11. For example, the gas is sealed in order to make it difficult for the heat generated at a coil 21 to be transferred to the tubular portion 11. Accordingly, the gas is preferably a gas having a low thermal conductivity. The gas can be, for example, xenon (Xe), krypton (Kr), a mixed gas of krypton and nitrogen gas, or the like. The krypton ratio can be 90% or more when the mixed gas of krypton and nitrogen gas is used. When xenon is used in this case, the heat generated at the coil 21 being transferred to the tubular portion 11 can be effectively suppressed. The manufacturing cost can be reduced using krypton or a mixed gas of krypton and nitrogen gas.

In addition, the gas is capable of containing a halogen substance such as bromine and iodine. For example, a trace amount of dibromomethane (CH₂Br₂) or the like can be contained in the aforementioned xenon, krypton, or the like.

The gas pressure (sealing pressure) of the internal space of the tubular portion 11 at 25° C. can be, for example, approximately 0.6 bar (60 kPa) to 0.9 bar (90 kPa). Here, the gas pressure (sealing pressure) of the internal space of the tubular portion 11 at 25° C. can be determined from the standard state of gas (standard ambient temperature and pressure (SATP): temperature 25° C., 1 bar).

The sealing portions 12 are provided in both end portions of the tubular portion 11 in the pipe axial direction. By providing the sealing portions 12 in the both end portions of the tubular portion 11, the internal space of the tubular portion 11 is airtightly sealed. For example, the pair of sealing portions 12 can be formed by crushing the vicinity of both ends of the tubular portion 11 that has been heated. For example, the pair of sealing portions 12 can be formed by a pinch seal method or a shrink seal method. The sealing portion 12 that has a plate shape as exemplified in FIG. 1 is formed when the sealing portion 12 is formed by the pinch seal method. The sealing portion 12 that is columnar is formed when the sealing portion 12 is formed by the shrink seal method.

The protrusion portion 13 is provided on the outer surface of the tubular portion 11. The protrusion portion 13 is provided so that the internal space of the tubular portion 11 is exhausted or the aforementioned gas is introduced into the internal space of the tubular portion 11 when the heater 100 is manufactured. For example, the protrusion portion 13 is formed by burning off a pipe formed from quartz glass after the exhaust and gas introduction.

The dimples 14 are, for example, locally protruding inner wall parts of the tubular portion 11. The dimples 14 can be formed by heating the tubular portion 11 and locally pressing the outer surface of the tubular portion 11. Accordingly, the outer surface of the tubular portion 11 at the position where the dimple 14 is formed is recessed toward the inner portion of the tubular portion 11.

The dimple 14 protrudes from the inner wall of the tubular portion 11 into the internal space of the tubular portion 11 and is in contact with an anchor 23. For example, a pair of the dimples 14 facing each other in the pipe radial direction can be provided and the anchor 23 can be held by the pair of dimples 14. The position of the anchor 23 can be maintained when the dimple 14 is provided.

A plurality of the dimples 14 can be provided in the pipe axial direction when a plurality of the anchors 23 are provided. In this case, the dimple 14 can be provided for each of the plurality of anchors 23 or the dimples 14 can be provided at predetermined intervals. In the case of the heat generating portion 1 exemplified in FIG. 1, the pair of dimples 14 are provided with respect to some of the anchors 23. It should be noted that the number and disposition of the dimples 14 can be appropriately changed in accordance with, for example, the total length L of the tubular portion 11 or the number of the anchors 23. In addition, the dimple 14 can be omitted depending on, for example, the total length L of the tubular portion 11 or the number of the anchors 23. In other words, the dimple 14 may be provided as needed.

The heating element 20 is provided in the tubular portion 11 and extends along the pipe axial direction of the tubular portion 11. The heating element 20 is electrically connected to the conductive portions 30.

The heating element 20 has, for example, the coil 21, legs 22, and the anchors 23.

The coil 21 and the leg 22 are, for example, integrally formed. The material of the coil 21 and the leg 22 can be, for example, tungsten.

The coil 21 has a spiral shape. The coil 21 can be formed by, for example, spirally winding a tungsten wire. The coil 21 has, for example, a cylindrical overview shape. The coil 21 generates heat when energized and emits light containing infrared rays.

The legs 22 are respectively provided in both side end portions of the coil 21. The leg 22 has a linear shape and extends from the end portion of the coil 21 along the pipe axial direction of the tubular portion 11. One end portion of the leg 22 is connected to the end portion of the coil 21 in the internal space of the tubular portion 11, and the other end portion is connected to the conductive portion 30 in the sealing portion 12. The vicinity of the end portion of the leg 22 can be, for example, laser-welded or resistance-welded to the conductive portion 30.

The anchor 23 is provided in the internal space of the tubular portion 11. The material of the anchor 23 can be, for example, tungsten. The anchor 23 can be formed by, for example, bending a tungsten wire.

One end portion side of the anchor 23 can be wound around, for example, the outer surface of the coil 21. The other end portion side of the anchor 23 can be brought into contact with, for example, the inner wall of the tubular portion 11. For example, the other end portion side of the anchor 23 has a curved shape along the inner wall of the tubular portion 11. The one end portion side of the anchor 23 is provided on the outer surface of the coil 21, and the other end portion side of the anchor 23 comes into contact with the inner wall of the tubular portion 11. As a result, the anchor 23 supports the coil 21 in the internal space of the tubular portion 11. The anchor 23 is a support member supporting the coil 21 with respect to the inner wall of the tubular portion 11.

For example, one conductive portion 30 is provided with respect to one sealing portion 12. The conductive portion 30 is provided in the sealing portion 12. The planar shape of the conductive portion 30 can be, for example, a quadrangle. The conductive portion 30 is formed from, for example, molybdenum foil.

At least one lead 40 can be provided with respect to one conductive portion 30. The lead 40 has a linear shape. One end portion side of the lead 40 is connected to the conductive portion 30 in the sealing portion 12. For example, the one end portion side of the lead 40 is laser-welded or resistance-welded to the conductive portion 30. The other end portion side of the lead 40 is exposed from the sealing portion 12. The lead 40 can be formed from, for example, a molybdenum wire.

The coating film 50 can be provided on the outer surface of the tubular portion 11. The coating film 50 can be provided as needed.

The coating film 50 can be, for example, a reflective film. The coating film 50 that is a reflective film is capable of covering a part of the outer surface (for example, half of the outer surface) in the cross section of the tubular portion 11 orthogonal to the pipe axial direction. The coating film 50 that is a reflective film can be formed from a material having a high reflectance to infrared rays. The coating film 50 that is a reflective film can be formed by, for example, applying a material containing silica, a zirconium compound, and aluminum oxide as main components to a partial region of the outer surface of the tubular portion 11. When the coating film 50 that is a reflective film is provided, infrared rays that contribute to heating can be emitted in a predetermined direction. Accordingly, the heating efficiency can be improved. In addition, heating of a device provided with the heater 100 or the like can be suppressed.

In addition, when the heater 100 is used for space heating or the like, for example, so-called anti-glare properties may be required in order to prevent a user from being dazzled. In such a case, the coating film 50 can be, for example, an anti-glare film (film having anti-glare properties). The coating film 50 that is an anti-glare film can be provided so as to cover the outer surface of the tubular portion 11. The coating film 50 that is an anti-glare film transmits the generated infrared rays when the heat generating portion 1 is energized and suppresses the transmission of the generated light in a visible light region (such as a region with a wavelength of 380 nm to 780 nm).

The coating film 50 that is an anti-glare film can be, for example, a laminated film in which low and high refractive index films are alternately laminated. The low refractive index film contains, for example, a silicon oxide such as silicon dioxide (SiO₂) and silicon oxide (SiO), magnesium fluoride (MgF₂), and the like. The high refractive index film contains, for example, an iron oxide such as iron oxide (III) (Fe₂O₃), a copper oxide such as copper oxide (I) (Cu₂O) and copper oxide (II) (CuO), and the like. The low and high refractive index films can be formed by, for example, a dip method, a vacuum deposition method, a sputtering method, or the like.

The bases 110 are respectively provided in both side end portions in the pipe axial direction of the two heat generating portions 1 provided side by side. The bases 110 store the sealing portions 12 of the two heat generating portions 1 provided side by side.

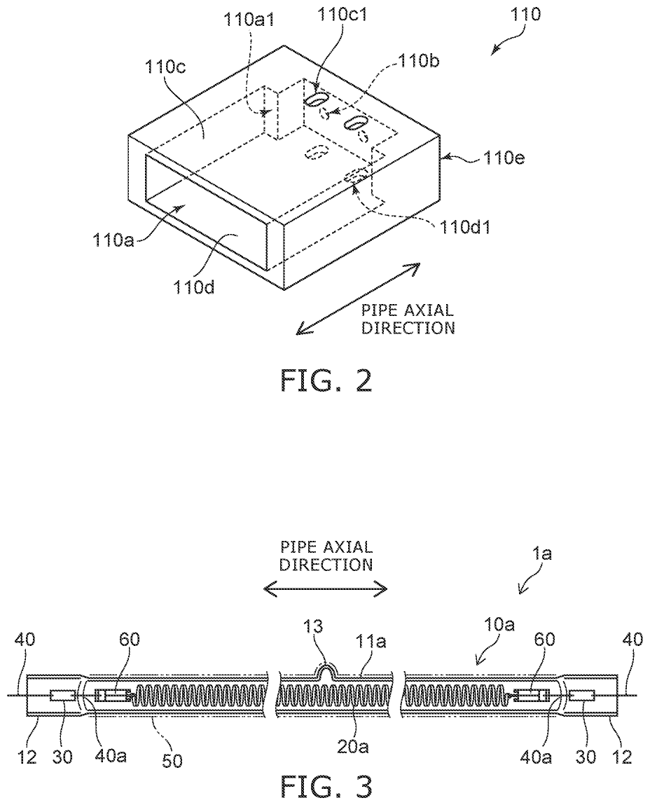

FIG. 2 is a schematic perspective view of the base 110.

As illustrated in FIG. 2, the appearance shape of the base 110 can be, for example, a substantially rectangular parallelepiped. It should be noted that the appearance shape of the base 110 can be appropriately changed in accordance with, for example, the number and disposition of the heat generating portions 1 to be stored. The base 110 may have, for example, a columnar or prismatic appearance shape when, for example, one heat generating portion 1 is to be stored.

A space 110a that opens to one end face of the base 110 is provided in the base 110. The inner wall of the base 110 is provided with a pair of projecting portions 110a1 protruding into the space 110a. The sealing portion 12 is stored in the region of the space 110a where the projecting portion 110a1 is not provided. The region of the space 110a that is provided with the projecting portion 110a1 stores the lead 40 exposed from the sealing portion 12, the connecting portion 120, and an end portion of an introduction wire 140 (harness) and is filled with the material that becomes the seal portion 130.

Two holes 110b are provided in a surface 110e of the base 110, which is on the side opposite to the side where the space 110a opens. The distance (pitch) between the centers of the two holes 110b can be substantially equal to the distance between the pipe axes of the two heat generating portions 1 provided side by side. The position of the center of the hole 110b can be substantially the same as the position of the center of the lead 40 exposed from the sealing portion 12 and stored in the space 110a. The introduction wire 140 is inserted into each of the two holes 110b. The hole 110b can be a lead-out hole for the introduction wire 140.

In addition, two holes 110c1 (corresponding to an example of a first hole) are provided in a surface 110c of the base 110, which intersects with the surface where the space 110a opens. The hole 110c1 extends in the pipe axial direction of the tubular portion 11. For example, the length of the hole 110c1 in the pipe axial direction is longer than the length of the hole 110c1 in a direction orthogonal to the pipe axial direction. The distance (pitch) between the centers of the two holes 110c1 can be substantially equal to the distance between the pipe axes of the two heat generating portions 1 provided side by side. When viewed from the direction orthogonal to the pipe axial direction, the two holes 110c1 overlap the region of the space 110a where the projecting portion 110a1 is provided. The hole 110c1 is provided at a position facing the connecting portion 120 and communicates with the space 110a. For example, the position of the center of the hole 110c1 is capable of substantially overlapping the position of the center of the connecting portion 120 stored in the space 110a.

In addition, two holes 110d1 (corresponding to an example of a second hole) are provided in a surface 110d of the base 110, which faces the surface 110c. The hole 110d1 extends in the pipe axial direction of the tubular portion 11. For example, the length of the hole 110d1 in the pipe axial direction is longer than the length of the hole 110d1 in the direction orthogonal to the pipe axial direction. For example, the hole 110d1 can be substantially identical to the hole 110c1 in dimension, shape and disposition. For example, the hole 110d1 faces the hole 110c1 and communicates with the space 110a. The hole 110d1 is capable of substantially overlapping the hole 110c1 when viewed from, for example, the direction orthogonal to the pipe axial direction.

As will be described later, the holes 110c1 and 110d1 are supply holes for filling the space 110a with the material that becomes the seal portion 130 and observation holes for visually confirming the filling state of the material. Accordingly, when the holes 110c1 and 110d1 are too small, the material filling may become difficult or it may become difficult to see the filling state. In contrast, when the holes 110c1 and 110d1 are too large, the rigidity, waterproofness, or the like of the base 110 may decrease.

According to the knowledge obtained by the present inventor, the length of the holes 110c1 and 110d1 in the pipe axial direction is preferably 5 mm or more and 10 mm or less. The length of the holes 110c1 and 110d1 in the direction orthogonal to the pipe axial direction is preferably 3 mm or more and 6 mm or less. In this manner, the material filling, the filling state confirmation, and the like can be facilitated and a decline in the rigidity, waterproofness, or the like of the base 110 can be suppressed.

The base 110 can be formed from an insulating and heat-resistant material. The base 110 can be formed from, for example, ceramics.

When the base 110 is formed from a brittle material such as ceramics, the planar shape of the holes 110c1 and 110d1 is preferably an end portion corner-less shape. For example, the planar shape of the holes 110c1 and 110d1 can be a shape in which the curve of a semicircle or the like constitutes an end portion. In this manner, stress concentration can be mitigated, and thus cracking, chipping, or the like of the base 110 can be suppressed.

As illustrated in FIG. 1, the connecting portion 120 can be provided in an end portion of the introduction wire 140. The connecting portion 120 can be, for example, a metal member for gathering a plurality of core wires provided at the introduction wire 140. The connecting portion 120 can be, for example, a crimping terminal such as a splice terminal. In addition, the connecting portion 120 is electrically connected to the lead 40 exposed from the sealing portion 12. For example, the vicinity of an end portion of the lead 40 can be laser-welded to the connecting portion 120.

One end portion side of the introduction wire 140 is electrically connected to the connecting portion 120. The introduction wire 140 can be a so-called heat-resistant electric wire. The introduction wire 140 can be, for example, an electric wire in which a plurality of core wires are coated with polytetrafluoroethylene (PTFE) or another fluororesin.

The introduction wire 140 is connected to the connecting portion 120 and is led out of the base 110 via the hole 110b provided in the surface 110e of the base 110.

The seal portion 130 has insulation and heat resistance and covers the lead 40 exposed from the sealing portion 12, the connecting portion 120, and the end portion of the introduction wire 140 in the space 110a of the base 110. In this case, the seal portion 130 is provided in the region of the space 110a where the projecting portion 110a1 is provided.

Furthermore, the seal portion 130 is capable of covering the inner portions of the holes 110c1 and 110d1.

In addition, the seal portion 130 is in close contact with, for example, the inner wall of the base 110, the lead 40 exposed from the sealing portion 12, the connecting portion 120, and the end portion of the introduction wire 140. Furthermore, the seal portion 130 can be in close contact with, for example, the inner walls of the holes 110c1 and 110d1.

The seal portion 130 can be formed by, for example, filling the region of the space 110a where the projecting portion 110a1 is provided with an insulating and heat-resistant material via the holes 110c1 and 110d1. The material with which the region is filled can be, for example, a silicone resin. The material filling can be performed using a dispenser or the like.

As described above, the holes 110c1 and 110d1 extend in the pipe axial direction of the tubular portion 11. Accordingly, the position of the dispenser or the like can be moved when, for example, the material filling is performed. When the material supply position can be moved, it becomes easy to gaplessly fill the space 110a with the material. In addition, the material supply position can be observed from, for example, the side of the dispenser, and thus it becomes easy to visually confirm the material filling state.

Accordingly, insufficient material filling can be suppressed, and thus the waterproofness (insulation) provided by the seal portion 130 can be improved.

FIG. 3 is a schematic view for exemplifying a heat generating portion 1a according to another embodiment.

The heat generating portion 1a has, for example, a heating element 20a containing carbon whereas the heat generating portion 1 described above has the heating element 20 containing tungsten. The heat generating portion 1a can be, for example, a carbon heater.

A change in the material of the heating element results in a change in the spectrum of the emitted light. For example, in the case of the heating element 20a containing carbon, the energy of the emitted light peaks at a wavelength of 2 μm to 4 μm. The peak of the absorption spectrum of water is around 3 μm, and thus an object with a high water content can be efficiently heated using the heating element 20a containing carbon.

As illustrated in FIG. 3, the heat generating portion 1a can be provided with, for example, a bulb 10a, the heating element 20a, the conductive portion 30, the lead 40, an inner lead 40a, a connecting portion 60, and the coating film 50.

The bulb 10a has, for example, a tubular portion 11a, the sealing portion 12, and the protrusion portion 13. The tubular portion 11a, the sealing portion 12, and the protrusion portion 13 can be integrally formed.

The tubular portion 11a can be similar to the tubular portion 11 described above. However, the heating element 20a does not have to be provided with the anchor 23, and thus the dimple 14 can be omitted.

The heating element 20a is capable of containing carbon. The heating element 20a has, for example, a spiral shape. The heating element 20a is formed by, for example, spirally winding a band-shaped mesh structure containing carbon or a linear body containing carbon fibers. The heating element 20a has, for example, a cylindrical overview shape. The heating element 20a is provided in the internal space of the tubular portion 11a. The heating element 20a extends along the pipe axial direction of the tubular portion 11a in the middle region of the tubular portion 11a. The heating element 20a generates heat when energized and emits light containing infrared rays. It should be noted that the heating element 20a may be, for example, a tubular mesh structure containing carbon fibers, a band-shaped body containing carbon, a linear body containing carbon, or the like. The heating element 20a exemplified in FIG. 3 is a band-shaped mesh structure containing carbon fibers and wound in a spiral shape.

Both side end portions of the heating element 20a extend along the pipe axial direction of the tubular portion 11a. Each of the both side end portions of the heating element 20a is connected to the connecting portion 60 in the internal space of the tubular portion 11a. In addition, the heating element 20a is pulled when the both side end portions of the heating element 20a are connected to the connecting portion 60. In this manner, contact between the heating element 20a and the inner wall of the tubular portion 11a can be suppressed.

Here, in the case of the heating element 20a containing carbon, it is difficult to directly connect the heating element 20a to the conductive portion 30. Accordingly, the heat generating portion 1a is provided with the inner lead 40a and the connecting portion 60.

At least one inner lead 40a can be provided with respect to one conductive portion 30. One inner lead 40a exemplified in FIG. 3 is provided with respect to one conductive portion 30. The inner lead 40a can be provided on the side of the conductive portion 30 that is opposite to the lead 40 side. The inner lead 40a has a linear shape. In each sealing portion 12, one end portion side of the inner lead 40a can be provided in the sealing portion 12 and the other end portion side can be exposed in the tubular portion 11a.

The inner lead 40a contains, for example, molybdenum. The inner lead 40a is connected to the conductive portion 30 in the sealing portion 12. For example, the inner lead 40a can be laser-welded or resistance-welded to the conductive portion 30.

The connecting portion 60 is provided in the internal space of the tubular portion 11a. The two connecting portions 60 can be respectively connected to the both side end portions of the heating element 20a. For example, the connecting portions 60 hold the heating element 20a by sandwiching the end portions of the heating element 20a. For example, the connecting portions 60 hold the inner leads 40a by hooking or sandwiching end portions of the inner leads 40a.

The connecting portion 60 can be formed from a heat-resistant and conductive material. The connecting portion 60 contains, for example, a metal such as nickel and a nickel alloy.

The base 110, the connecting portion 120, and the seal portion 130 can be attached to the heat generating portion 1a as well as the heat generating portion 1 described above. In other words, exemplary embodiments described herein can be applied even when the material or shape of the heating element is different.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A heater comprising:
a tubular portion;
a sealing portion provided in an end portion of the tubular portion;
a conductive portion provided in the sealing portion;
a heating element provided in the tubular portion,
extending along a pipe axial direction of the tubular portion, and electrically connected to the conductive portion;
a lead having one end portion side electrically connected to the conductive portion in the sealing portion with the other end portion side exposed from the sealing portion;
a connecting portion electrically connected to the lead exposed from the sealing portion;
an introduction wire having one end portion side electrically connected to the connecting portion;
a base storing the sealing portion, the lead exposed from the sealing portion, the connecting portion, and an end portion of the introduction wire in an internal space; and
a seal portion covering the lead exposed from the sealing portion, the connecting portion, and the end portion of the introduction wire in the space of the base,
the base having a first hole communicating with the space at a position facing the connecting portion, and
a length of the first hole in the pipe axial direction being longer than a length of the first hole in a direction orthogonal to the pipe axial direction.

2. The heater according to claim 1, wherein the space is open to a first surface of the base.

3. The heater according to claim 2, wherein the first hole is provided in a second surface of the base intersecting with the first surface.

4. The heater according to claim 3, wherein a second hole facing the first hole and communicating with the space is provided in a third surface of the base facing the second surface.

5. The heater according to claim 1, wherein the first hole has a length of 5 mm or more and 10 mm or less in the pipe axial direction.

6. The heater according to claim 1, wherein the first hole has a length of 3 mm or more and 6 mm or less in the direction orthogonal to the pipe axial direction.

7. The heater according to claim 1, wherein the first hole has a planar shape in which a curve constitutes an end portion.

8. The heater according to claim 1, wherein the seal portion further covers an inner portion of the first hole.

9. The heater according to claim 4, wherein a length of the second hole in the pipe axial direction is longer than a length of the second hole in the direction orthogonal to the pipe axial direction.

10. The heater according to claim 4, wherein the second hole is identical to the first hole in dimension, shape, and disposition.

11. The heater according to claim 4, wherein the second hole overlaps the first hole when viewed from the direction orthogonal to the pipe axial direction.

12. The heater according to claim 4, wherein the second hole has a length of 5 mm or more and 10 mm or less in the pipe axial direction.

13. The heater according to claim 4, wherein the second hole has a length of 3 mm or more and 6 mm or less in the direction orthogonal to the pipe axial direction.

14. The heater according to claim 4, wherein the second hole has a planar shape in which a curve constitutes an end portion.

15. The heater according to claim 4, wherein the seal portion further covers an inner portion of the second hole.

16. The heater according to claim 2, wherein a third hole is provided in a fourth surface of the base facing the first surface and the introduction wire is inserted in the third hole.

17. The heater according to claim 1, wherein the base has a rectangular parallelepiped, columnar, or prismatic appearance shape.

18. The heater according to claim 1, wherein the base is formed from an insulating and heat-resistant material.

19. The heater according to claim 1, wherein the base is formed from ceramics.

20. The heater according to claim 1, wherein the seal portion contains a silicone resin.
